(19) United States
(12) Patent Application Publication
(10) Pub. No.: US 2020/0392650 A1
(43) Pub. Date: Dec. 17, 2020

(54) SPINNING MACHINE

(71) Applicant: Saurer Intelligent Technology AG, Arbon (CH)

(72) Inventors: Philipp Schiffers, Erkelenz-Gerderath (DE); Lothar Uedinger, Möchengladbach (DE); Heiko Toepke, Baesweiler (DE)

(21) Appl. No.: 16/899,896

(22) Filed: Jun. 12, 2020

(30) Foreign Application Priority Data
Jun. 14, 2019 (DE) 102019116234.3

(51) Int. Cl. D01H 1/115; D01H 13/30

(52) U.S. Cl. CPC D01H 1/115; B29L 2031/707; D01H 13/306

(57) ABSTRACT

A spinning machine having several spinning positions, the spinning machine having an air flow supply unit for providing compressed air and/or suction air at the spinning positions and a drafting system support extending along the spinning positions, for detachably arranging drafting systems at the spinning positions. In order to provide a spinning machine that allows compressed air and/or suction air to be supplied to the spinning positions in an energy-efficient manner, it is provided that the drafting system support is designed as a longitudinally channeled tube body having a flow connection to the air flow supply unit and having connection openings assigned to the individual spinning positions.

### CROSS-REFERENCE TO RELATED APPLICATION

This application claims priority from German National Patent Application No. 10 2019 116 234.3, filed Jun. 14, 2019, entitled “Spinnmaschine”, the entire contents of which are incorporated herein by reference.

### FIELD OF THE INVENTION

The invention relates to a spinning machine having several spinning positions, the spinning machine having an air flow supply unit for providing compressed air and/or suction air at the spinning positions and a drafting system support extending along the spinning positions, for detachably arranging drafting systems at the spinning positions.

### BACKGROUND OF THE INVENTION

Spinning machines of the aforementioned type have a large number of spinning positions of the same kind, which, inter alia, require suction air and/or compressed air at least intermittently for their various processes, which air is usually provided by one or more air flow supply units of the spinning machine. For the sake of simplicity and without limiting the general validity, only one single air flow supply unit will be referred to below in the context of the application.

On spinning machines, the suction air is typically used, for example, for a thread trapping and cleaning nozzle, which, during the spinning process, cleans loose particles and also performs a safety function of trapping the lower thread in the event of certain thread breaks. The thread trapping and cleaning nozzle is therefore continuously supplied with suction air at least during regular operation. Likewise, for example a rotor cup of an open-end spinning machine is supplied with suction air during regular spinning operation and also during piecing.

In certain kinds of spinning machine, in particular air-jet spinning machines, in which a yarn is manufactured from a strand-shaped fiber material with the help of a vortex air flow generated inside a vortex chamber by air nozzles, a drafting system serves as the delivery device for the strand-shaped fiber material. In the case of an air-jet spinning machine, the drafting system is located upstream of a spinning nozzle in the spinning direction and the fiber material is conveyed by an output roller pair of the drafting system toward an inlet opening of a spinning nozzle and is suctioned by the latter by means of negative pressure.

A continuous supply of suction air and/or compressed air to the spinning machines or the working elements of the spinning machines, including any drafting systems used, is of great importance for consistent quality of the yarn to be manufactured. However, due to the long and in particular angled line runs, it is currently necessary to use air flow supply units that have high energy demand in order to provide the compressed air and/or suction air necessary for the smooth operation of the spinning machine; angled lines and sharply bent branch-offs in particular have a negative effect on the air flow.

### SUMMARY OF THE INVENTION

Proceeding therefrom, the problem addressed by the invention is that of providing a spinning machine that allows compressed air and/or suction air to be supplied to the spinning positions in an energy-efficient manner.

The invention solves the problem by means of a spinning machine having several spinning positions, the spinning machine comprising an air flow supply unit for providing compressed air and/or suction air at the spinning positions and a drafting system support extending along the spinning positions, for detachably arranging drafting systems at the spinning positions, characterized in that, the drafting system support has a longitudinally channeled tube body having a flow connection to the air flow supply unit and having connection openings assigned to the individual spinning positions.

Advantageous further developments of the invention are presented herein. The spinning machine is characterized in that the tube body and/or the longitudinal channel has a circular cross-section. The spinning machine is characterized by an air flow controller connected to the air flow supply unit. The spinning machine is characterized in that the air flow controller is arranged in a housing of a spinning machine control unit. The spinning machine is characterized in that the air flow controller is arranged in the longitudinal axis direction of the longitudinally channeled tube body or in a section of the longitudinally channeled tube body. The spinning machine is characterized in that the tube body is of a multi-piece design, more particularly is designed for the connection of additional tube bodies. The spinning machine is characterized in that the connection opening is connected to a connecting line, in particular a flexible connecting line, for the flow-tight connection of the spinning positions, in particular the drafting system, to the tube body.

The spinning machine according to the invention is characterized in that the drafting system support is designed as a longitudinally channeled tube body having a flow connection to the air flow supply unit and having connection openings assigned to the individual spinning positions.

The drafting system support, which extends along the spinning positions and is designed to detachably receive the drafting systems at the spinning positions, is designed as a longitudinally channeled tube body according to the invention so that the compressed air and/or suction air can be conducted through it to the individual spinning positions, in particular the drafting systems. For this purpose, the tube body is connected to the air flow supply unit in a flow-tight manner, so that the compressed air and/or suction air provided by the air flow supply unit is conducted directly into the longitudinal channel of the tube body. To provide the compressed air and/or suction air at the individual spinning positions, the tube body has individual connection openings in the area of the spinning positions, through which connection openings the spinning positions and/or the drafting system can be supplied with compressed air and/or suction air.

Because of the design of the drafting system support according to the invention as a longitudinally channeled tube body, it can be used both for detachably arranging the drafting systems at the spinning positions and for supplying compressed air and/or suction air to the spinning positions, in particular the drafting systems, in an energy-efficient manner. It is particularly advantageous for supplying compressed air and/or suction air in an energy-efficient manner that the drafting system support extends consistently, without deflections of the air flow by sharply bent line routing, along a longitudinal axis along the spinning positions. A pressure drop or flow reduction, in particular due to turbulent flows resulting from line routing with sharp bends, is thus reliably avoided, since the air flow runs along the spinning positions in a straight line within the tube body, where the air flow is made available at the individual spinning positions.

Employing the drafting system support, in accordance with the invention, to supply the spinning positions with compressed air and/or suction air makes it possible to dispense with the use of multiply branching lines, which are known from the prior art, so that air flow supply units with lower energy demand in comparison with the spinning machines known from the prior art can be used. Furthermore, the tube body extending in the longitudinal axis direction prevents the deposition of dirt within the tube body, which is usually deposited only in the area of the sharp bends of sharply bent lines. Employing the drafting system support as a supply line for supplying the spinning positions with compressed air and/or suction air also makes it possible to dispense with additional lines. According to the present invention, the drafting system support fulfils a double function. It is used both for detachably arranging drafting systems and for supplying the spinning positions with compressed air and/or suction air.

In principle, the outer shape of the tube body and the cross-section of the longitudinal channel can be freely chosen. Thus, the outer shape of the tube body can be adapted to the arrangement of the drafting systems, whereas the cross-section of the longitudinal channel can be designed for optimal guidance of the compressed air and/or suction air. However, according to a particularly advantageous embodiment of the invention it is provided that the tube body and/or the longitudinal channel has a circular cross-section. In particular, the design of the tube body and the longitudinal channel with a circular cross-section allows the drafting system support to be manufactured in a particularly simple and economical manner as a tube body. A circular design of the outside of the tube body makes it possible for the drafting systems with a corresponding receptacle to be swiveled around the tube body from a removal position to an installation position. A circular cross-section of the longitudinal channel ensures particularly good air flow within the tube body.

In principle, pressure control or volumetric flow rate control can be carried out directly at the air flow supply unit. However, according to a particularly advantageous embodiment of the invention, an air flow controller connected to the air flow supply unit is provided. Employing a separate air flow controller allows the air flow controller to be arranged in an area easily accessible to a machine operator. Adjustments to the pressure and/or the volumetric flow rate of the air flow supply units can thus be made conveniently without direct access to the air flow supply unit. Furthermore, the longitudinally channeled design of the tube body allows, in a preferred way, the air flow controller to be arranged in the longitudinal axis direction of the tube body or in a section of the longitudinally channeled tube body, which makes it possible to dispense with sharp bends or branch-offs which would otherwise be necessary in order to integrate the air flow controller into the air flow path between the air flow supply unit and the first connection opening that follows in the air flow path.

According to a particularly advantageous embodiment of the invention, it is provided that the air flow controller is arranged in a housing of a spinning machine control unit. Arranging the air flow controller in a spinning machine control unit, which controls all the spinning positions of the spinning machine, makes it possible to dispense with a separate housing for an air flow controller connected to the air flow supply unit. The spinning machine control unit can then be used by a machine operator both to make settings at the spinning machine and to make settings of the air flow supply unit.

In principle, the drafting system support can be designed as a single-piece tube body. However, according to a particularly advantageous embodiment of the invention it is provided that the tube body is of a multi-piece design, more particularly is designed for the connection of additional tube bodies. This embodiment of the invention allows the tube body to be optimally adapted to the length of the spinning machine. Especially in the event that tube bodies of different lengths are available, which can be connected to one another, the tube body can be optimally adapted to the number of spinning positions of the spinning machine or to spinning position segments having a defined number of spinning positions. The tube bodies can be connected, for example, by means of suitable screw, clamp, plug-in or locking connections.

According to the invention, the tube body has connection openings assigned to the individual spinning positions, through which connection openings compressed air and/or suction air can be provided at the spinning positions. According to a particularly advantageous embodiment, it is provided that the connection opening is connected to a connecting line, in particular a flexible connecting line, for the flow-tight connection of the spinning positions, in particular the drafting system, to the tube body. The arrangement of a connecting line at the connection opening, in particular a flexible connecting line, allows the spinning position, in particular a drafting system arranged directly on the tube body, to be connected in a particularly quick and easy manner. In particular, the flexible connecting line can be used to compensate for positional inaccuracies of the connection openings in relation to the spinning position and/or the drafting system.

According to a further embodiment of the invention, it is also provided that the connection openings are designed with means for controlling the air flow through the connection openings. According to this embodiment of the invention, it is possible for the compressed air and/or suction air provided at the individual connection openings to be individually controlled using said means. These can be, for example, adjustable orifices or slide controls which limit the volumetric flow rate. This embodiment allows individual and optimal adaptation of the suction air and/or compressed air provided at the individual spinning positions.

Further areas of applicability of the present invention will become apparent from the detailed description provided hereinafter. It should be understood that the detailed description and specific examples, while indicating the preferred embodiments of the invention, are intended for purposes of illustration only and are not intended to limit the scope of the invention.

### BRIEF DESCRIPTION OF THE DRAWINGS

An embodiment example of the invention is explained below with reference to the drawings. In the drawings:

FIG. 1 shows a basic representation of an air flow supply unit connected to a drafting system support designed as a tube body and

FIG. 2 shows a perspective illustration of a spinning position with a drafting system arranged on a drafting system support.

### DESCRIPTION OF THE PREFERRED EMBODIMENTS

The following description of the embodiments of the present invention is merely exemplary in nature and is in no way intended to limit the invention, its application, or uses. The following description is provided herein solely by way of example for purposes of providing an enabling disclosure of the invention, but does not limit the scope or substance of the invention.

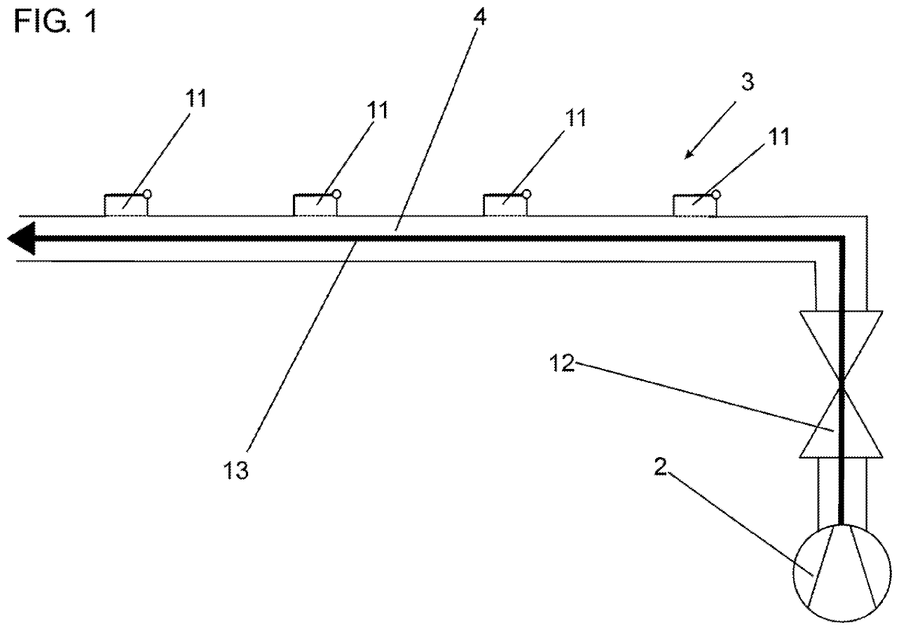

FIG. 1 shows a schematic representation of an air flow supply of a textile machine having several spinning positions 1. The source of the air flow 13, which can be compressed air and/or suction air, is an air flow supply unit 2. The air flow supply unit 2 is connected via an air flow controller 12 to a drafting system support 3, which is designed as a tube body 4. For the connection of spinning machine units, in particular the drafting system 7, to the air flow supply unit, the tube body 4 has connection pieces 11, which are spaced apart from one another and have connection openings 5. An air flow 13 conducted through the tube body 4 can be tapped via the connection pieces 11 if required.

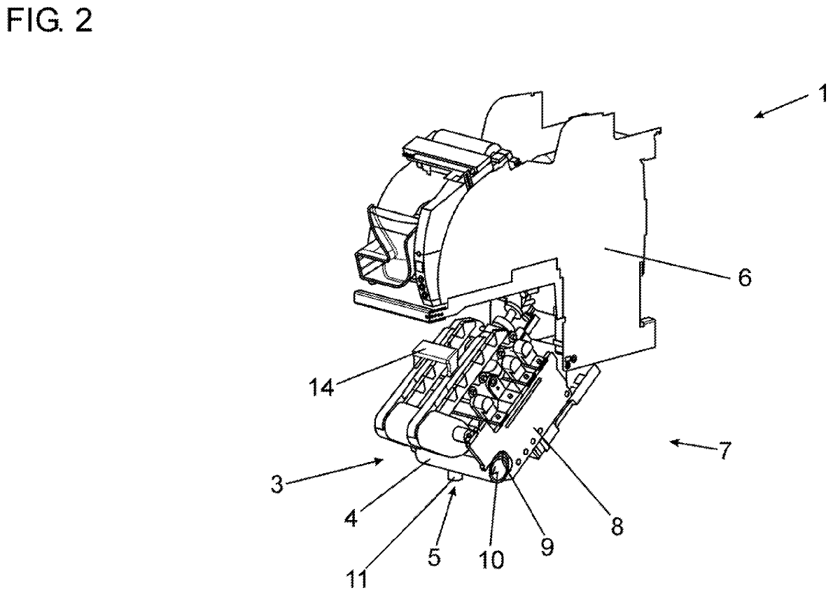

The drafting system support 3 designed as a tube body 4 is used not only for conducting the air flow 13 but also for detachably arranging a drafting system 7 at a spinning position 1 of the air-jet spinning machine 6. A supporting frame 8 of the drafting system 7 has a recess 9 for this purpose, which is matched to the outside diameter of the tube body 4. A handle configured as a gripping element 14 facilitates adjustment of the top rollers of the drafting system in relation to the bottom rollers as well as, in the locked condition, pivoting of the drafting system around the tube body 4. The interior of the tube body 4 of the drafting system support 3 forms a longitudinal channel 10 for conducting the air flow 13, which can be tapped via the connection openings 5 of the connection pieces 11 if required (see FIG. 2).

### LIST OF REFERENCE SIGNS

1 Spinning position
2 Air flow supply unit
3 Drafting system support
4 Tube body
5 Connection opening
6 Air-jet spinning machine
7 Drafting system
8 Supporting frame
9 Recess
10 Longitudinal channel
11 Connection piece
12 Air flow controller
13 Air flow
14 Gripping element

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

What is claimed is:

1. A spinning machine having several spinning positions, the spinning machine comprising an air flow supply unit for providing compressed air and/or suction air at the spinning positions and a drafting system support extending along the spinning positions, for detachably arranging drafting systems at the spinning positions,
characterized in that
the drafting system support has a longitudinally channeled tube body having a flow connection to the air flow supply unit and having connection openings assigned to the individual spinning positions.

2. The spinning machine according to claim 1, characterized in that the tube body and/or the longitudinal channel has a circular cross-section.

3. The spinning machine according to claim 1, characterized by an air flow controller connected to the air flow supply unit.

4. The spinning machine according to claim 3, characterized in that the air flow controller is arranged in a housing of a spinning machine control unit.

5. The spinning machine according to claim 3, characterized in that the air flow controller is arranged in the longitudinal axis direction of the longitudinally channeled tube body or in a section of the longitudinally channeled tube body.

6. The spinning machine according to claim 1, characterized in that the tube body is of a multi-piece design.

7. The spinning machine according to claim 1, characterized in that the tube body is designed for the connection of additional tube bodies.

8. The spinning machine according to claim 1, characterized in that the connection opening is connected to a connecting line for the flow-tight connection of the spinning positions to the tube body.

9. The spinning machine according to claim 1, characterized in that the connection opening is connected to a connecting line for the flow-tight connection of the drafting system to the tube body.

10. The spinning machine according to claim 8, characterized in that the connecting line is a flexible connecting line.

11. The spinning machine according to claim 1, characterized in that the connection openings are designed with control for the air flow through the connection opening.
